(19) United States
(12) Patent Application Publication
(10) Pub. No.: US 2016/0263809 A1
(43) Pub. Date: Sep. 15, 2016

(54) DEVICE AND METHOD FOR COOLING PROFILED PLASTIC SECTIONS

(71) Applicants: Wolfgang SEDLACEK, Wien (AT); Dietmar STANI, Wien (AT); BATTENFELD-CINCINNATI AUSTRIA GMBH, Wien (AT)

(72) Inventors: Wolfgang Sedlacek, Vienna (AT); Dietmar Stani, Vienna (AT)

(21) Appl. No.: 15/028,964

(22) PCT Filed: Oct. 10, 2014
(86) PCT No.: PCT/EP2014/071822

§ 371 Date: Apr. 13, 2016

(30) Foreign Application Priority Data
Oct. 14, 2013 (DE) 102013220746.8

(51) Int. Cl. B29C 47/88

(52) U.S. Cl. CPC B29C 47/882; B29C 47/8815; B29L 2031/757

(57) ABSTRACT

A device and a method for increasing the cooling power of an extrusion line and for extruding a profiled plastic section in an energy-efficient manner, in particular a plastic tube, having at least one extruder; a tool which shapes the profiled section, the tool having at least one inner ring and an outer ring, wherein the inner ring and the outer ring are connected by webs; a calibrating unit; and additional subsequent devices.

### CROSS-REFERENCE TO RELATED APPLICATIONS

This application is a U.S. national stage application under 35 U.S.C. §371 of International Application No. PCT/EP2014/071822, filed on Oct. 10, 2014, and claims benefit to German Patent Application No. DE 10 2013 220 746.8, filed on Oct. 14, 2013. The International Application was published in German on Apr. 23, 2015, as WO 2015/055549 Al under PCT Article 21(2).

### FIELD

The invention concerns an apparatus for increasing the cooling capacity of an extrusion line and for the energy efficient extrusion of a plastic profile, especially a plastic tube.

### BACKGROUND

Known from prior art is the DE 10 2008 047 211 A1, an extrusion line for the production of plastic profiles, preferably plastic tubes, comprising at least an extruder, a tool, a calibration, as well as further downstream devices, in which at least the tool features at least one opening, with an extraction unit arranged before the tool, by means of which the air inside the plastic profile can be exchanged.

This inner cooling of the profile by means of extraction increases the cooling capacity and/or shortens the cooling zone. A tempering of the plastic melt within the tool so as to dissipate the heat as evenly as possible across the entire wall thickness, thus increasing the cooling capacity of an extrusion line, is described in DE 10 2008 047 209 A1.

This, however, always requires the extraction of air through the opening of the tool and the hollow profile, as well as the use of a cooling medium that tempers the plastic melt within the tool.

### SUMMARY

An aspect of the invention provides an apparatus for increasing a cooling capacity of an extrusion line and for energy efficient extrusion of a plastic profile, the apparatus comprising: an extruder; a tool configured to give shape to the plastic profile, the tool including an inner rim and an outer rim; a crosspiece, the inner rim and outer rim being connected by one or more crosspieces; a calibration; and a further downstream device, wherein one or several of the crosspieces connecting the inner rim and outer rim include a channel configured to create a fluidic connection between an inlet area for a cooling medium and a profile hollow.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a typical extrusion line;

FIG. 2 a section with an extruder and a tool; and

FIG. 3 a section through the tool.

### DETAILED DESCRIPTION

An aspect of the invention further develops a known apparatus in a way that makes it possible to forego the opening in the tool while still allowing for a cooling through the inside of the profile. Furthermore, a corresponding process will be offered.

An aspect of the invention provides an apparatus for increasing the cooling capacity of an extrusion line and for the energy efficient extrusion of a plastic profile, especially a plastic tube, comprising at least one extruder, a tool to give shape to the profile, comprising at least an inner and an outer rim, the inner and outer rim being connected by crosspieces, a calibration as well as further downstream devices. The invention also further concerns a corresponding process

An aspect of the apparatus is characterized correspondingly to the generic concept of claim 1 in that one or several of the crosspieces connecting the inner and outer rim feature a channel creating the fluidic connection between the inlet area for a cooling medium on the one hand and the profile hollow on the other.

It is thus possible to forego the opening in the tool, because e.g. air can be blown from the outer rim via the channel in the crosspiece to the inner rim into the hollow of the profile and then released into the environment. In principle, one crosspiece with a channel would suffice. However, to ensure a better distribution of the melt, two or three crosspieces are necessary, not each of which obligatorily needs to feature a channel for the injection of the cooling medium. The number of crosspieces should increase along with the diameter of cross-section of the profile.

In accordance with the concept to further develop the given apparatus, several crosspieces arranged in a single plane are provided. A section perpendicular to the extrusion axis through the crosspieces would thus mean a section through all crosspieces, since they are arranged in a single plane. Thus, all channels within the crosspieces can relatively easily be connected with a blower device via a ring channel.

It is also possible to arrange several levels with several crosspieces or several crosspieces on several levels in a row so as to convey a more effective cooling to the extrustion line.

Preferably, the crosspieces are symmetrically distributed around the perimeter. The crosspieces can also be arranged vertically, obliquely and/or offset to the direction of extrusion. Depending on the field of application, a bearer ring can be placed between the inner and the outer rim.

In principle, the apparatus can also be applied in reverse direction of the flow of the gaseous medium. In this case, a sucking device replaces the blower device and the above-described blow effect becomes a suction effect, that is, a blowing of the applied gas, e.g. air, is to be understood as a suction of the same.

Correspondingly to the generic concept of claim 8, the purpose of the process is resolved by blowing a gaseous medium through the plastic profile in extrusion direction for inner cooling of the profile, the gaseous medium being blown through at least one channel in a crosspiece within the tool, the gaseous medium being furthermore blown through the profile before being released into the surrounding air.

E.g. air is blown through the tool via the channels in the crosspieces through the inside of the profile to the end of the extrusion line and then released into the environment.

The air can obviously also be blown through several channels of the above-described apparatus, thus altering the blowing capacity or the flow velocity of the air through the inside of the profile.

As stated above, air is proposed as the gaseous medium, but it is also possible to use other suitable media, such as cooled nitrogen etc.

As stated above, the apparatus can also be used to suck the gaseous medium, which of course analogously applies also to the claimed process. The gaseous medium is then sucked through the profile and at least one channel in crosspiece within the tool and then released into the environment.

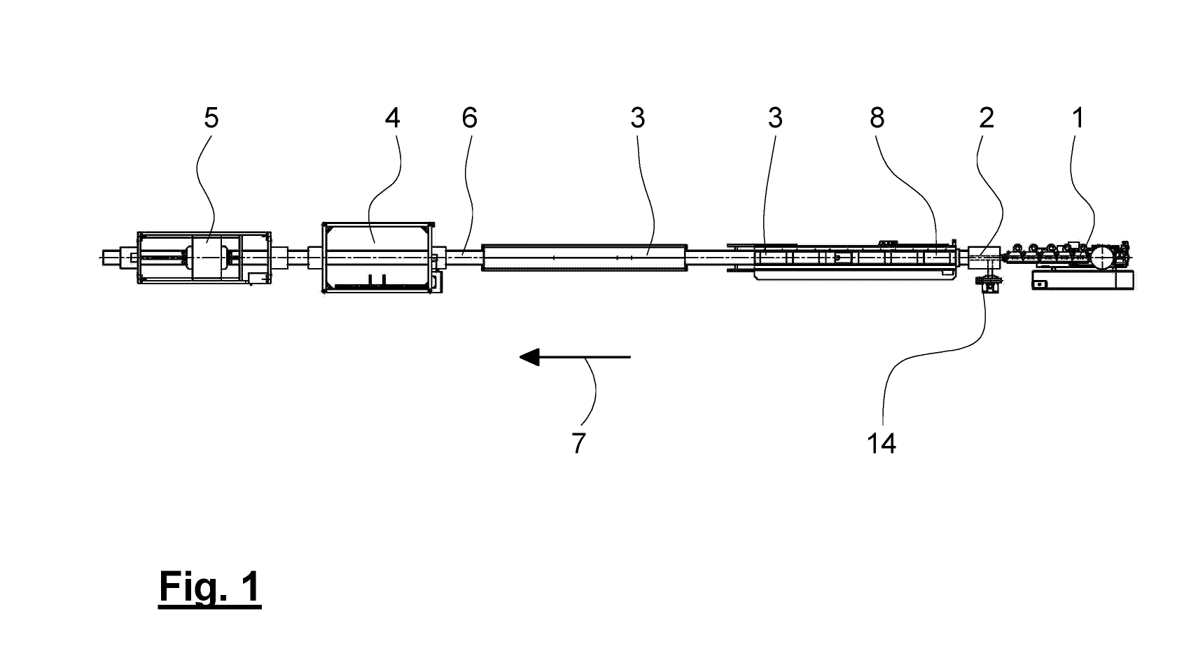

FIG. 1 shows a typical extrusion line as used nowadays for profile extrusion, e.g. for the production of window profiles or tubes. It shows an extruder (1) in which plastic is molten and continuously fed to the extrusion tool (2), to which a calibration and/or cooling device (3) is attached. Depending on the profile, further cooling stations can be applied. An extraction device (4) follows after the cooling stations. To cut the continuous profiles (6) to the intended length, a cutting device (5) follows the extraction device (4). All components are arranged along the extrusion axis (8). The direction of extrusion is indicated by the arrow (7). A ventilator (14) is arranged directly at the tool (2) to suck the gaseous medium (11), in this case air, and blow it through the apparatus.

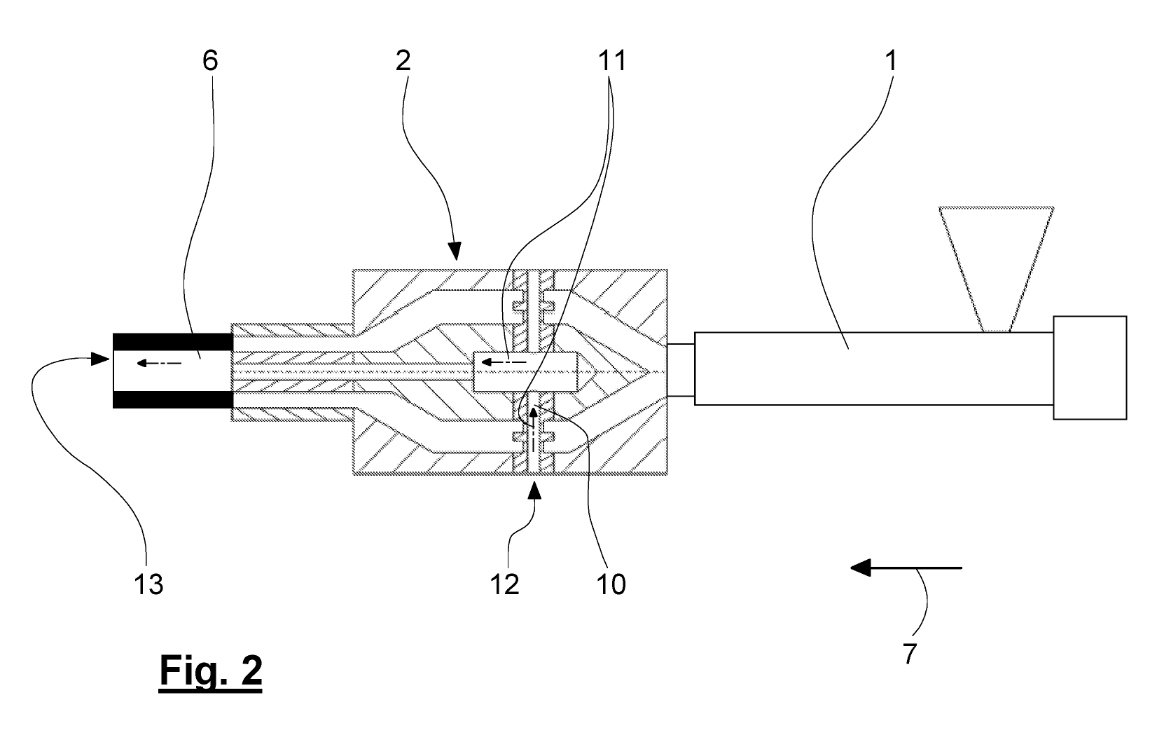

FIG. 2 shows a section with the extruder (1) and the tool (2) that gives shape to the profile (6), in this case a plastic tube, before it is calibrated and hardened to ensure dimensional stability by means of several of the downstream devices depicted in FIG. 1. A gaseous medium (11) is blown through the tool (2) and the inside of the profile (6). The gaseous medium (11), preferably air, is blown from the inlet area (12) at the tool (2) through channels (10) in the crosspieces (9) into the profile (6), conveyed through its inside and released into the environment at the outlet area (13) at the end of the profile (6). The extrusion direction is again indicated by the arrow (7).

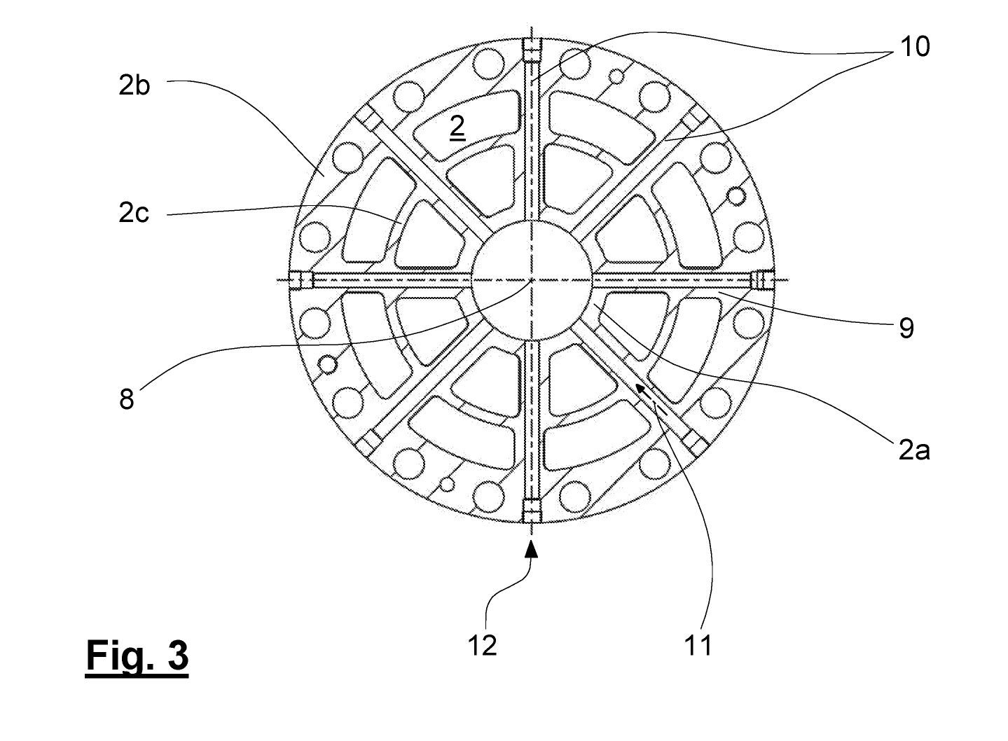

FIG. 3 shows a cross-section through the tool (2), the section being perpendicular to the extrusion axis (8) through the crosspieces (9) and displaying only the components relevant to the description of the invention. As the section is perpendicular to the extrusion axis (8), the extrusion axis (8) is depicted as only a dot. The tool comprises an inner rim (2a) and an outer rim (2b) around the axis of extrusion (8). Both parts are connected by crosspieces (9), of which this figure exemplarily shows eight. Additionally, a bearer ring (2c) is arranged between the outer rim (2a) and the inner rim (2b), further distributing the melt. However, the bearer ring (2c) is not obligatory.

All eight crosspieces are arranged in a single plane and feature a channel (10) each. On one side, at the inner rim (2a) the channel has a fluidic connection to the profile hollow and thus also to the environment. On the other side, at the outer rim (2b), the fluidic connection exists between the channel and the ventilator (14).

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### LIST OF REFERENCE SIGNS

1 Extruder
2 Extrusion tool
2a Inner rim
2b Outer rim
2c Bearer ring
3 Calibration and/or cooling device
4 Extraction device
5 Cutting device
6 Profile
7 Extrusion direction
8 Extrusion axis
9 Crosspiece between 2a and 2b
10 Channel in 9
11 Gaseous medium
12 Inlet area for 11
13 Outlet area for 11
14 Ventilator

1. An apparatus for increasing a cooling capacity of an extrusion line and for energy efficient extrusion of a plastic profile, the apparatus comprising:
an extruder;
a tool configured to give shape to the plastic profile, the tool including an inner rim and an outer rim;
a crosspiece, the inner rim and outer rim being connected by one or more crosspieces;
a calibration; and
a further downstream device,
wherein one or several of the crosspieces connecting the inner rim and outer rim include a channel configured to create a fluidic connection between an inlet area for a cooling medium and a profile hollow.

2. The apparatus of claim 1, comprising two or more crosspieces, each including a channel,
wherein the crosspieces are arranged in a single plane.

3. The apparatus of claim 2, wherein the crosspieces are arranged in two or more levels.

4. The apparatus of claim 1, wherein the crosspieces are symmetrically distributed around a perimeter.

5. The apparatus of claim 1, wherein the crosspieces are arranged vertically relative to an extrusion direction.

6. The apparatus of claim 1, wherein the crosspieces are arranged obliquely.

7. The apparatus of claim 1, further comprising:
a bearer ring is arranged between the inner rim and the outer rim.

8. A process for increasing a cooling capacity of an extrusion line and for energy efficient extrusion of a plastic profile, the process comprising:
a) melting a plastic in an extruder;
b) shaping a plastic strand and feeding the plastic strand into a tool, the tool including an inner rim and an outer rim;
c) shaping a plastic profile using the tool, to obtain a shaped profile; and
d) calibrating and hardening through cooling the shaped profile in a cooling and/or calibration device,
wherein a gaseous medium is blown in an extrusion direction through the plastic profile for inner cooling of the plastic profile,
wherein the gaseous medium is blown through at least one channel in a crosspiece within the tool, and
wherein the gaseous medium is furthermore passed through the profile before being released into the environment.

9. The process of claim 8, wherein the gaseous medium includes air.

10. The process of claim 8, further comprising:
sucking the gaseous medium through the plastic profile and through the at least one channel in a crosspiece within the tool.

11. The process of claim 8, which produces a plastic tube.

12. The process of claim 8, wherein the gaseous medium consists essentially of air.

13. The process of claim 8, wherein the gaseous medium is blown through the profile before being released into the environment.

14. The apparatus of claim 1, configured to produce a plastic tube.

15. The apparatus of claim 1, wherein the crosspieces are arranged offset.

16. The apparatus of claim 1, wherein the crosspieces are arranged obliquely and offset.
